(19) United States
(12) Patent Application Publication
(10) Pub. No.: US 2012/0063013 A1
(43) Pub. Date: Mar. 15, 2012

(54) FOCUS ADJUSTING EQUIPMENT

(75) Inventors: Masashi Shiozawa, Saitama-ken (JP); Shinya Aikawa, Tokyo (JP)

(73) Assignee: KABUSHIKI KAISHA TOSHIBA, Tokyo (JP)

(21) Appl. No.: 13/189,650

(22) Filed: Jul. 25, 2011

(30) Foreign Application Priority Data
Sep. 14, 2010 (JP) 2010-205078

(51) Int. Cl. G02B 7/04

(52) U.S. Cl. 359/811

(57) ABSTRACT

According to one embodiment, focus adjusting equipment is provided. The focus adjusting equipment is provided with a rotational driving unit, a focus lens unit, a cam gear and a cam. The rotational driving unit generates a rotational force. The focus lens unit is provided with a focus lens and a motion converting unit. The focus lens is movable in an optical axis direction. The motion converting unit converts a rotational motion into a linear motion of the focus lens. The cam gear rotates in association with the rotation of the rotational driving unit. The cam rotates with the cam gear integrally. The cam contacts with an actuating part of the motion converting unit so as to transmit the rotational motion of the cam gear to the motion converting unit.

### CROSS-REFERENCE TO RELATED APPLICATION(S)

This application is based upon and claims the benefit of priority from the prior Japanese Patent Application No. 2010-205078, filed on Sep. 14, 2010, the entire contents of which are incorporated herein by reference.

### FIELD

Embodiments described herein relate generally to focus adjusting equipment.

### BACKGROUND

Various projectors have been employed for consumer and industrial uses. In recent years, attention has been paid to a small-sized projector such as a PICO projector or a short focus projector with the progress of miniaturization and lower power consumption of various apparatuses.

Many types of PICO projectors have been developed for use of cellular phones, game machines, small-sized digital cameras etc. Such PICO projectors are provided with built-in focus adjusting equipment. The built-in focus adjusting equipment is required to be further reduced in volume for miniaturization of the small-sized projector such as the PICO projector.

### BRIEF DESCRIPTION OF THE DRAWINGS

FIG. 1 is a perspective view illustrating a PICO projector using focus adjusting equipment according to a first embodiment.

FIG. 2 is a perspective view illustrating the focus adjusting equipment of the first embodiment.

FIG. 3A is a top view illustrating the focus adjusting equipment.

FIG. 3B is a front view illustrating the focus adjusting equipment.

FIG. 4 is a diagram illustrating a positional relationship between a cam and a focus lens of the focus adjusting equipment.

FIG. 5 is a diagram illustrating a positional relationship between a cam and a lens of the focus adjusting equipment which is different from the positional relationship shown in FIG. 4.

FIG. 6 is a diagram illustrating a relationship between a cam rotation angle and a displacement amount of the focus adjusting equipment.

FIG. 7 is a schematic diagram illustrating a relationship between a cam and an actuating part of focus adjusting equipment of a second embodiment.

FIG. 8 is a diagram illustrating a relationship between a cam rotation angle and a displacement amount of the focus adjusting equipment according to the second embodiment.

FIG. 9 is a perspective view illustrating a focus lens unit.

### DETAILED DESCRIPTION

According to one embodiment, focus adjusting equipment is provided. The focus adjusting equipment is provided with a rotational driving unit, a focus lens unit, a cam gear and a cam. The rotational driving unit generates a rotational force. The focus lens unit is provided with a focus lens and a motion converting unit. The focus lens is movable in an optical axis direction. The motion converting unit converts a rotational motion into a linear motion of the focus lens. The cam gear rotates in association with the rotation of the rotational driving unit. The cam rotates with the cam gear integrally. The cam contacts with an actuating part of the motion converting unit of the focus lens unit so as to transmit the rotational motion of the cam gear to the motion converting unit of the focus lens unit.

Hereinafter, further embodiments will be described with reference to the drawings.

In the drawings, the same reference numerals denote the same or similar portions respectively.

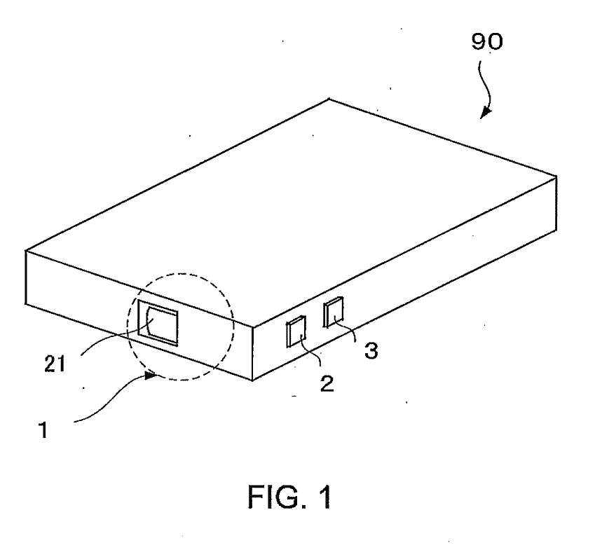

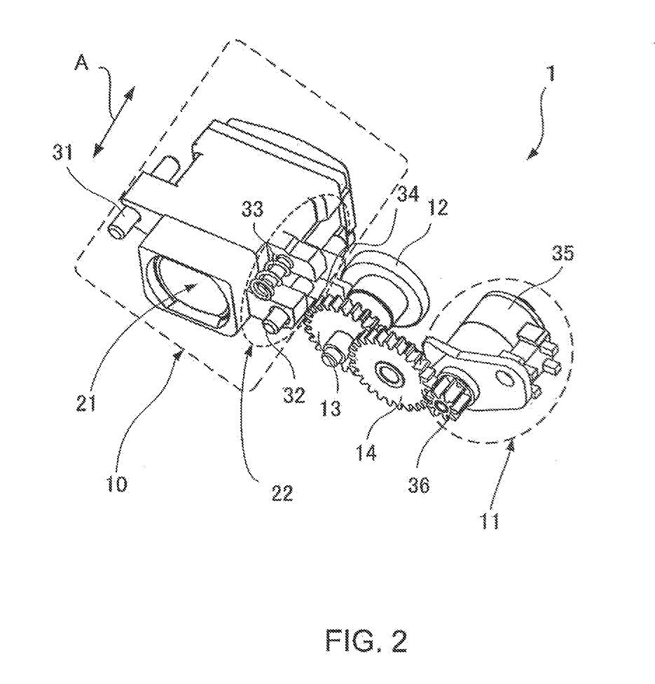

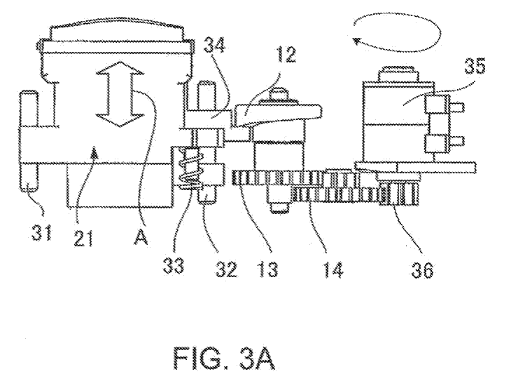

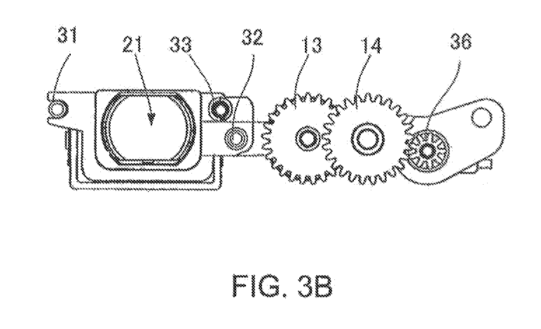

A first embodiment will be described with reference to FIGS. 1, 2, 3A, 3B and 9. FIG. 1 is a perspective view to show a PICO projector. FIGS. 2, 3A, and 3B are a perspective view, a top view, and a front view illustrating focus adjusting equipment according to the first embodiment, respectively.

In the embodiment, an endless return type cam with an angle of 360° is used in electric focus adjusting equipment.

As shown in FIG. 1, a PICO projector 90 is provided with electrically-driven focus adjusting equipment 1, an operation button 2, and an operation button 3. The PICO projector 90 is used as a small-sized image projecting apparatus. The PICO projector 90 may be installed in a cellular phone, a game machine, a small-sized digital camera etc.

The focus adjusting equipment 1 is provided with a focus lens 21 for image projection. In FIG. 1, the operation buttons 2 and 3 are disposed at a side surface perpendicular to a surface where the focus lens 21 is arranged. The disposition of the operation buttons 2 and 3 is not limited to that shown in FIG. 1. The operation buttons 2, 3 are used as a button for adjusting the position of the focus lens 21, for example. When a user operates the operation buttons 2, 3, the position of the focus lens 21 arranged in the focus adjusting equipment 1 is adjusted.

As shown in FIG. 2, the focus adjusting equipment 1 is provided with a focus lens unit 10, a rotational driving unit 11, a cam 12, a cam gear 13, and a relay gear 14.

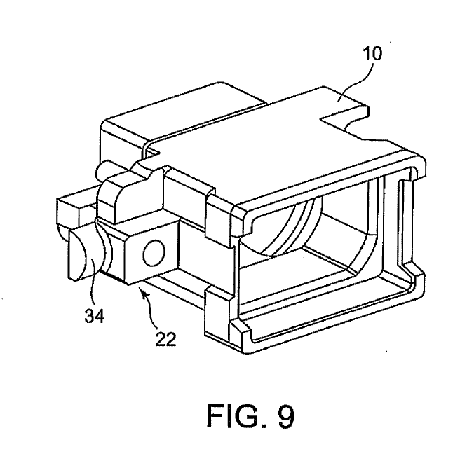

The focus lens unit 10 is provided with a focus lens 21, a motion converting unit 22, and a secondary guide shaft 31. The motion converting unit 22 is provided with a primary guide shaft 32, a compression spring 33, and an actuating part 34. As shown in FIG. 9, the section of the actuating part 34 has a semicircle shape and the circular arc portion of the semicircle shape contacts with a cam surface of the cam 12, in order to keep the actuating part 34 in linear contact with the cam surface, to reduce contact load on the cam surface and to assure adjustment positional accuracy.

In FIG. 2, the secondary guide shaft 31 and the primary guide shaft 32 have a function of moving the focus lens unit 10 only in an optical axis direction A of the PICO projector 90. The rotational driving unit 11 is provided with a stepping motor 35 and a motor gear 36. The motion converting unit 22 is disposed to face the cam 12.

As shown in FIGS. 3A and 3B, in the focus adjusting equipment 1, a rotational motion generated in the stepping motor 35 is converted into a linear motion by the motion converting unit 22 so that the focus lens 21 moves along the optical axis direction A.

An operation of the focus adjusting equipment 1 will be described in detail below. When the stepping motor 35 serving as a rotational driving source starts to rotate, the rotational motion is transmitted to the motor gear 36 connected to the stepping motor 35.

The transmitted rotational motion is transmitted to the relay gear 14 engaged with the motor gear 36. The rotational motion of the relay gear 14 is transmitted to the cam gear 13 engaged with the relay gear 14, and, further, the rotational motion is transmitted to the cam 12 connected to the cam gear 13.

The height of the cam surface of the cam 12 changes continuously along a circumferential direction of the cam 12. Specifically, as shown in FIG. 3A, a left portion of the cam 12 is higher than a right portion of the cam 12, and the height of the cam 12 increases from the right portion toward the left portion gradually.

At the actuating part 34 in contact with the cam surface of the cam 12, the rotational motion of the cam 12 is converted into a linear motion of the optical axis direction A, due to height differences of the cam surface. The compression spring 33 has a function of bringing the cam surface of the cam 12 into contact with the actuating part 34 normally.

Since the motion converting unit 22 and the focus lens 21 are integrated, the two perform the same linear motion. Using this linear motion, the focus lens 21 can project an image to an object.

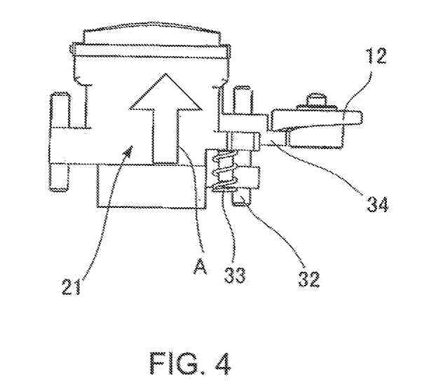

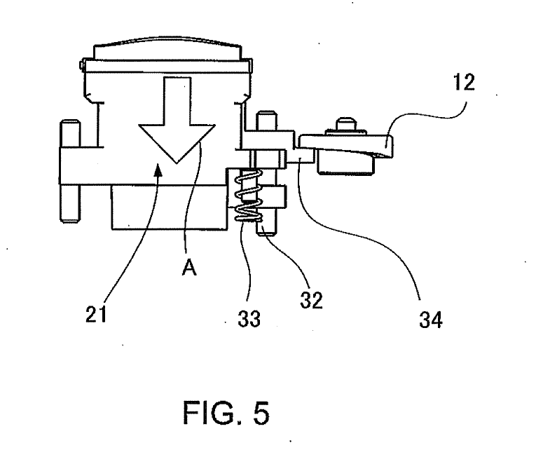

The operation of the focus adjusting equipment will be described with reference to FIGS. 4 to 6. FIGS. 4 and 5 show relationships between the cam and the lens at the outermost position (in FIG. 4, the most downward position) of the focus lens 21 and the innermost position (in FIG. 5, the most upward position) of the focus lens 21, respectively.

As shown in FIG. 4, when the focus lens 21 is positioned at the outermost position, the actuating part 34 comes into contact with the highest position of the cam surface of the cam 12 in the down direction.

On the other hand, as shown in FIG. 5, when the focus lens 21 is positioned at the innermost position, the actuating part 34 comes into contact with the lowest position of the cam surface of the cam 12 in the down direction.

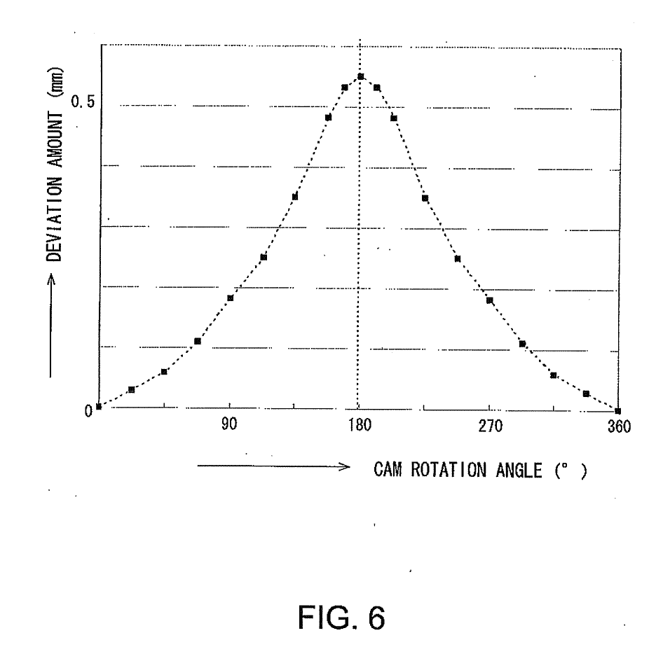

FIG. 6 is a diagram illustrating a relationship between a cam rotation angle of the focus adjusting equipment 1 and a displacement amount of the actuating part 34. As shown in FIG. 6, the displacement amount of the focus lens 21 can be set by the cam rotation angle.

Specifically, when the cam rotation angle becomes 0° (zero degree) i.e. in the case of FIG. 5, the displacement amount becomes the minimal value. When the cam rotation angle increases, the displacement amount increases gradually. When the cam rotation angle becomes 180° i.e. in the case of FIG. 4, the displacement amount becomes the maximal value. When the cam rotation angle increases from 180°, the displacement amount decreases gradually. When the cam rotation angle becomes 360° i.e. in the case of FIG. 5, the displacement amount becomes the minimal value. The displacement amount distribution has a wave form symmetrical about a cam rotation angle of 180°, i.e., as to right and left sides in FIG. 6. There are two cam rotation angles where the displacement amounts are the same except for the displacement amount of the maximal value.

The cam 12 performs, for example, an operation of moving the focus lens 21 from the innermost position to the outermost position and returning the focus lens to the innermost position, which is a 360-degree endless return operation. The shape of the cam 12 may be appropriately changed so that change of moving amount of the focus lens 21 are set desirably.

As described above, the focus adjusting equipment of the embodiment is arranged in the PICO projector 90 having the operation buttons 2, 3. The focus adjusting equipment 1 is provided with the focus lens unit 10, the rotational driving unit 11, the cam 12, the cam gear 13, and the relay gear 14. The cam 12 may perform an endless operation with an angle of 360°.

Since the actuating part 34 provided in the focus lens unit 10 contacts with the cam surface of the cam 12 normally by means of the compression spring 33, a sensor for detecting the position of the mechanical moving end is not needed, and a mechanical stopper is not necessary either. Furthermore, since the cam surface of the cam 12 contacts with the actuating part 34 normally and the cam 12 performs an endless return operation with an angle of 360°, damage or abrasion of components is remarkably suppressed.

Accordingly, in the embodiment, it is possible to reduce the volume of the focus adjusting equipment 1 and to reduce the number of components and the damage rate of the components.

In the embodiment, the 360-degree endless return type cam 12 is used in the focus adjusting equipment 1 which is provided in the PICO projector 90. The use of the focus adjusting equipment 1 is not necessarily limited to the PICO projector. For example, the focus adjusting equipment 1 may be used in various projectors such as a short focus projector.

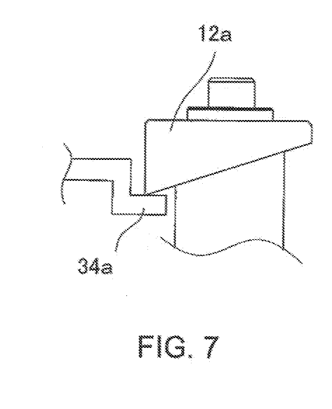

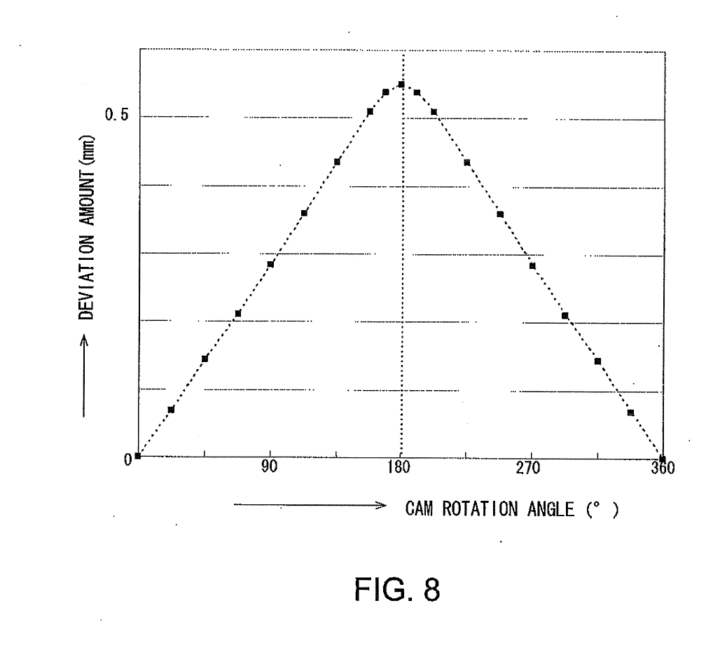

Focus adjusting equipment according to a second embodiment will be described with reference to FIGS. 7, 8. FIG. 7 is a schematic diagram to show a relationship between a cam and an actuating part arranged in the focus adjusting equipment of the second embodiment. FIG. 8 is a diagram to illustrate a relationship between a cam rotation angle and a displacement amount in the focus adjusting equipment.

As shown in FIG. 7, a cam surface of a cam 12a in contact with an actuating part 34a has a linear inclination. In the embodiment, the configurations other than the cam 12a and the actuating part 34a are same as those of the first embodiment.

As shown in FIG. 8, when the shape of the cam shown in FIG. 7 is used, the displacement amount of the focus lens 21 may be almost linearly changed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the above described embodiments, a mechanism including a cam is used in an electrically-driven focus adjusting equipment, but the mechanism including the cam may be used in auto-focus adjusting equipment. In the case of the auto-focus adjusting equipment, a position sensor and a control system needs to be provided.

In the above described embodiments, the relationship between a cam rotation angle and a displacement amount is symmetrical about the cam rotation angle of 180°, i.e., as to right and left sides of FIGS. 6, 8, but the relationship is not necessarily limited to the same.

What is claimed is:

1. Focus adjusting equipment comprising:
a rotational driving unit to generate a rotational force;
a focus lens unit provided with a focus lens and a motion converting unit, the focus lens being movable in an optical axis direction, the motion converting unit converting the a rotational motion into a linear motion of the focus lens;
a cam gear which rotates in association with the rotation of the rotational driving unit; and
a cam which rotates with the cam gear integrally, the cam contacting with an actuating part of the motion converting unit so as to transmit the rotational motion of the cam gear to the motion converting unit.

2. The equipment according to claim 1, wherein the motion converting unit is further provided with a guide to guide the movement of the focus lens and a compression spring to bring the actuating part into contact with the cam.

3. The equipment according to claim 1, wherein the cam has two different cam rotation angles at which the displacement amounts are the same.

4. The equipment according to claim 1, wherein a cam surface of the cam in contact with the actuating part has a linear inclination.

5. The equipment according to claim 1, wherein the rotational driving unit is provided with a stepping motor.

6. The equipment according to claim 5, wherein the stepping motor transmits the rotational motion to the cam gear through a motor gear and a relay gear.

7. The equipment according to claim 2, wherein the cam has two different cam rotation angles at which the displacement amounts are the same.

8. The equipment according to claim 3, wherein a cam surface of the cam in contact with the actuating part has a linear inclination.

9. The equipment according to claim 2, wherein the rotational driving unit is provided with a stepping motor and the stepping motor transmits the rotational motion to the cam gear through a motor gear and a relay gear.

10. The equipment according to claim 3, wherein the rotational driving unit is provided with a stepping motor and the stepping motor transmits the rotational motion to the cam gear through a motor gear and a relay gear.
